(19) United States
(12) Patent Application Publication
(10) Pub. No.: US 2016/0252627 A1
(43) Pub. Date: Sep. 1, 2016

(54) GEIGER-MULLER TUBE

(71) Applicant: JOHNSON MATTHEY PUBLIC LIMITED COMPANY, London (GB)

(72) Inventor: Aaron SHARPE, Surrey (GB)

(21) Appl. No.: 15/027,391

(22) PCT Filed: Oct. 10, 2014
(86) PCT No.: PCT/GB2014/053060

§ 371 Date: Apr. 5, 2016

(30) Foreign Application Priority Data
Oct. 11, 2013 (GB) 1318051.8

(51) Int. Cl. G01T 1/18; H01J 47/08

(52) U.S. Cl. CPC G01T 1/18; H01J 47/08

(57) ABSTRACT

An improved Geiger Müller tube includes an enclosed container having at least one metal wall forming a cathode, the metal wall including a layer of platinum, a metal anode spaced from the cathode, and elements to apply a voltage between the anode and the cathode, the enclosed container being filled with a gas mixture including a noble gas and a halogen including chlorine, bromine or a mixture thereof to a pressure of less than 0.2 atmospheres, characterized in that the platinum includes a surface layer of platinum tetrachloride and/or platinum tetrabromide having a thickness of at least 10 nm.

The present invention concerns Geiger-Müller (GM) tubes. in particular halogen-quenched GM tubes and improvements in their manufacture.

GM tubes include a container filled to a low pressure with a noble gas, a cathode and an anode. The performance of a GM tube is enhanced by the addition of a trace amount of a quench gas, typically a halogen, which is present to quench the ionisation of noble gas molecules to reduce the occurrence of spurious ionisation events which may affect the output of the GM tube. Metal Geiger tubes are typically manufactured from stainless steel. The walls of the tube usually form the cathode whilst the anode is a wire located centrally within the tube. Stainless steel may corrode as a result of prolonged contact with chlorine or bromine, which are typically used as quench gases. For that reason, the internal walls of the tube may be coated with a thin layer of platinum in order to protect the steel from contact with the quench gas. A known problem with platinum-coated GM tubes is that the halogen quench gas may become depleted over time. It is an object of the invention to provide a GM tube which exhibits a reduced amount of halogen depletion.

According to the invention, we provide a Geiger-Müller tube comprising an enclosed container having at least one metal wall forming a cathode, said metal wall comprising a layer of platinum, a metal anode spaced from said cathode, and means to apply a voltage between said anode and said cathode, said enclosed container being filled with a gas mixture comprising a noble gas and a halogen comprising chlorine, bromine or a mixture thereof to a pressure of equal to or less than 0.2 atmospheres, characterised in that said platinum comprises a surface layer of platinum tetrachloride and/or platinum tetrabromide.

By providing a surface layer of platinum tetrachloride (PtCl₄) or platinum tetrabromide (PtBr₄) on the platinum surface, the surface of the cathode becomes resistant to reaction with halogen, e.g. chlorine, so that halogen supplied as a quench gas is not removed from the atmosphere within the GM tube through reaction with the platinum. This greatly reduces or eliminates the failure of the GM tube by depletion of halogen, e.g. chlorine, through reaction with the cathode surface. In a preferred embodiment, the halogen is chlorine and the surface layer comprises platinum tetrachloride.

The surface layer may have an average thickness of from 10 to 100 nm. It is preferred that the minimum thickness of the surface layer of platinum tetrachloride and/or platinum tetrabromide is at least 10 nm.

The GM tube is of conventional construction. Typically the tube is made from a cylinder of metal which is often a stainless steel. The size of the GM tube may vary widely. GM tubes having a length from about 5 mm to about 300 mm are known commercially. The invention is not limited by the size or shape of the GM tube. The steel is coated on the interior-facing surface with a layer of platinum, which typically has a thickness between 1 and 100 microns. The platinum layer may be formed by electroplating or by other means known in the art. The ends of the tube are sealed by end caps made from a material such as glass or a ceramic material. The end caps are joined to the metal walls of the tube by a gas-tight join, for example by soldering. The end caps or sealing material may support the anode, typically in the form of a metal wire located at the centre of the tube.

The GM tube is filled with a gas mixture comprising a noble gas and a halogen, i.e. chlorine or bromine, to a pressure of equal to or less than 0.2 atmospheres. The GM tube may be filled with said gas mixture to a pressure of less than 0.2 atmospheres. The GM tube may be filled with said gas mixture to a pressure of less than 0.1 atmospheres. The gas mixture may comprise about 1-3 mol % of halogen, i.e. chlorine or bromine. Other gaseous compounds apart from chlorine, bromine and the noble gas may be present in trace amounts.

The PtCl₄ or PtBr₄layer may cover the entire surface of the platinum, or it may cover only a portion of the surface. Preferably at least 50%, more preferably at least 75% of the surface of the platinum is covered by PtCl₄ and/or PtBr₄.

A layer of another platinum compound may be present between the platinum metal surface and the PtCl₄. This other platinum compound may comprise a platinum dihalide such as platinum dichloride (PtCl₂) or platinum dibromide (PtBr₂). When the halogen is chlorine, it is preferred that at least 50% of the surface of the PtCl₂, if present, is covered by PtCl₄. At least 75% of the surface of the PtCl₂, if present, may be covered by PtCl₄. When the halogen is bromine, it is preferred that at least 50% of the surface of the PtBr₂, if present, is covered by PtBr₄. At least 75% of the surface of the PtBr₂, if present, may be covered by PtBr₄.

According to the invention, a method of manufacturing a GM tube comprises the steps of:
a) forming a container having at least one metal wall suitable for forming a cathode and having a metal anode located spaced apart from said cathode, said metal wall comprising a layer of platinum facing the interior of the container, and means to means to apply a voltage between said anode and said cathode,
b) filling the container with a gas containing a halogen selected from chlorine, bromine or a mixture of chlorine and bromine;
c) contacting the interior surface of the container with said gas at a temperature in the range 200-300° C.,
d) maintaining said contact until the reaction of the available surface of the cathode with the halogen-containing gas has attained a steady state, to form a treated container;
e) evacuating the container;
f) filling the treated enclosed container with a mixture of a noble gas and a halogen comprising chlorine, bromine or a mixture thereof, to a pressure of equal to or less than 0.2 atmospheres, and
g) sealing the container.

The steps b-e may be repeated one or more times.

Step c may be performed at a temperature in the range 200-300° C. Step c may be performed at a temperature in the range 250-300° C.

The halogen-containing gas may comprise substantially pure chlorine, pure bromine, a mixture of chlorine and bromine or alternatively, the chlorine and/or bromine may be diluted with another, preferably inert, gas, such as nitrogen or a noble gas. A preferred halogen is chlorine.

The objective of step d is to react the surface of the platinum layer with chlorine or bromine until all or substantially all of the reactive platinum species at the surface have reacted fully with chlorine or bromine to form PtCl₄ PtBr₄.

The contact of the halogen-(chlorine or bromine) containing gas may be maintained until the concentration of halogen in the container is stable, i.e. so that the halogen concentration remains substantially constant at the contact temperature of 200-300° C. This may be measured by measuring the concentration of halogen in the container. Alternatively a halogen-containing gas may be flowed through the container. The amount of halogen in the halogen-containing gas flowing from the container may be monitored to determine when the reaction of halogen with the cathode surface has attained a steady state.

In an embodiment of the method of the invention, the contact of chlorine- and/or bromine-containing gas is maintained until the platinum comprises a surface layer of platinum tetrachloride or platinum tetrabromide having a thickness of at least 10 nm.

The platinum may react with the chlorine-containing gas to form PtCl₂. PtCl₂ may react with the chlorine gas to form PtCl₄. Therefore the reaction of the cathode with the chlorine-containing gas may be a reaction of chlorine with platinum metal or with one or more compounds of platinum to form PtCl₄. The platinum may react with the bromine-containing gas, if present, to form PtBr₂. PtBr₂ may react with the bromine gas to form PtBr₄. Therefore the reaction of the cathode with the bromine-containing gas may be a reaction of bromine with platinum metal or with one or more compounds of platinum to form PtBr₄.

We have found that PtCl₂ may be formed at temperatures above about 350° C. Its formation may be through the mechanism of thermal decomposition of PtCl₄. When, however, a cathode surface comprising PtCl₂ is used in the finished GM tube containing a low pressure noble gas with a predetermined amount of chlorine as a quench gas, the PtCl₂ may react with the chlorine to reduce the available quench gas in the GM tube. In order that this problem can be avoided the method of the invention involves contact of the cathode surface with a chlorine-containing gas at a temperature at or below 350° C. so that PtCl₄ is formed as a surface layer. The invention has been described with reference to chlorine. Bromine may be present in the GM tube as a quench gas either in combination with chlorine or as an alternative to chlorine. Bromine also reacts with platinum and platinum compounds to form PtBr₂ and PtBr₄.

The GM tube is filled with a gas mixture comprising a noble gas and halogen to a pressure of equal to or less than 0.2 atmospheres. The GM tube may be filled with said gas mixture to a pressure of less than 0.2 atmospheres. The GM tube may be filled with said gas mixture to a pressure of less than 0.1 atmospheres. The gas mixture may comprise about 1-3 mol % of halogen. Other gaseous compounds apart from the halogen and the noble gas may be present in trace amounts.

In a typical manufacturing process, the tube will be formed from a stainless steel cylinder of the desired diameter and length. The tube will typically be cleaned using solvents prior to plating with platinum. The tube may then be electroplated with platinum. After the plating process the tube then has the end cap(s) and a filling spout attached. The filling spout is a temporary structure which enables the tube to be filled with gas and evacuated. The tube then undergoes a passivation and filling process. This step is typically carried out as a batch process with many tubes connected to a single fill line. Typically the tubes are heated to a temperature between 200 and 300° C., for example about 275° C. and cyclically saturated with the quench gas species, e.g. chlorine, and then evacuated until passivation is considered complete. After this, the final step is to fill with the low pressure fill gas mix and seal off the tube by sealing and optionally removing the filling spout.

1. A Geiger-Müller tube comprising an enclosed container having at least one metal wall forming a cathode, said metal wall comprising a layer of platinum, a metal anode spaced from said cathode, and means to apply a voltage between said anode and said cathode, said enclosed container being filled with a mixture of a noble gas and a halogen comprising chlorine, bromine or a mixture thereof, to a pressure of equal to or less than 0.2 atmospheres, wherein said platinum comprises a surface layer of platinum tetrachloride and/or platinum tetrabromide.

2. A Geiger-Müller tube according to claim 1, wherein said enclosed container is filled with a mixture of a noble gas and a halogen comprising chlorine, bromine or a mixture thereof, to a pressure of less than 0.2 atmospheres.

3. A Geiger-Müller tube according to claim 1, wherein said metal wall comprises a first metal layer and a second metal layer, said second metal layer overlaying the surface of said first metal layer on the interior of said enclosed container.

4. A Geiger-Müller tube according to claim 1, wherein said surface layer comprises platinum tetrachloride.

5. A Geiger-Müller tube according to claim 1, wherein said surface layer comprises platinum tetrabromide.

6. A Geiger-Müller tube according to claim 1, wherein said surface layer has a thickness of at least 10 nm.

7. A Geiger-Müller tube according to claim 1, wherein the gas mixture comprises 1-3 mol % of halogen.

8. A method of manufacturing a Geiger-Müller tube comprising the steps of:
a) forming a container having at least one metal wall suitable for forming a cathode and having a metal anode located spaced apart from said cathode, said metal wall comprising a layer of platinum facing the interior of the container, and means to means to apply a voltage between said anode and said cathode,
b) filling the container with a gas containing a halogen selected from chlorine, bromine or a mixture of chlorine and bromine;
c) contacting the interior surface of the container with said gas at a temperature in the range 200-300° C.,
d) maintaining said contact until the reaction of the available surface of the cathode with the halogen-containing gas has attained a steady state, to form a treated container;
e) evacuating the container;
f) filling the treated enclosed container with a mixture of a noble gas and a halogen comprising chlorine, bromine or a mixture thereof, to a pressure equal to or less than 0.2 atmospheres, and
g) sealing the container.

9. A method according to claim 8, wherein steps b) to e) are repeated one or more times.

10. A method according to claim 8, wherein, in step f) the treated enclosed container is filled with a mixture of a noble gas and a halogen comprising chlorine, bromine or a mixture thereof, to a pressure less than 0.2 atmospheres.

11. A method according to claim 8, wherein, in step d) the contact between surface of the cathode and the halogen-containing gas is maintained until said surface comprises a layer of PtCl₄ or PtBr₄ having a thickness of at least 10 nm.

12. A method according to claim 8, wherein the gas mixture comprises 1-3 mol % of halogen.

13. A method according to claim 8, wherein the halogen is chlorine.

14. A Geiger-Müller tube according to claim 2, wherein said metal wall comprises a first metal layer and a second metal layer, said second metal layer overlaying the surface of said first metal layer on the interior of said enclosed container.

15. A Geiger-Müller tube according to claim 2, wherein said surface layer has a thickness of at least 10 nm.

16. A method according to claim 9, wherein, in step f) the treated enclosed container is filled with a mixture of a noble gas and a halogen comprising chlorine, bromine or a mixture thereof, to a pressure less than 0.2 atmospheres.

17. A method according to claim 9, wherein, in step d) the contact between surface of the cathode and the halogen-containing gas is maintained until said surface comprises a layer of PtCl₄ or PtBr₄ having a thickness of at least 10 nm.
